(19) United States
(12) Patent Application Publication
(10) Pub. No.: US 2011/0193703 A1
(43) Pub. Date: Aug. 11, 2011

(54) WEARABLE FLUID-SENSITIVE HYGIENE COMPLIANCE DEVICE

(75) Inventors: Adriana Payton, La Habra, CA (US); Gavin Braithwaite, Cambridge, MA (US)

(73) Assignee: Adriana Payton, La Habra, CA (US)

(21) Appl. No.: 12/702,253

(22) Filed: Feb. 8, 2010

(51) Int. Cl. G08B 23/00

(52) U.S. Cl. 340/573.1

(57) ABSTRACT

Described are systems having for sensing that a hygiene activity has commenced and alerting a user upon completion of a minimum hygiene compliance period for that activity. For example, a wearable wrist-band can include a fluid sensor, timing circuitry, a power source, and an indicator. The fluid sensor can begin a timer which is configured to correspond to a minimum length of time for a hygiene protocol, and the indicator can indicate to a user when the minimum length of time has passed and the hygiene condition satisfied.

### BACKGROUND

1. Field

The present disclosure relates to methods and apparatuses for indicating compliance with hygiene standards.

2. Description of the Related Art

Although timing devices and fluid sensors exist, there remains a need for systems such as those described herein that can combine fluid sensitivity with precise timing, thereby providing an indication of a user's compliance with hygiene standards. The health care industry will especially benefit from the inventions and embodiments described herein.

### SUMMARY

In some embodiments, there is provided a hygiene compliance indicator. The hygiene compliance indicator can comprise a wearable device configured for wearing on or near a user's hand such that exposure of the hand to fluid while the hand is being washed leads to direct exposure of the device to washing fluid. The hygiene compliance indicator can further comprise a fluid sensor located on or in the wearable device and having at least one fluid-exposed portion that is sensitive to a physical trigger event, the trigger event comprising a physical interaction with a fluid, the fluid sensor further configured to provide a detection signal indicating that the physical trigger event has occurred, thereby transmitting information that such fluid interaction has occurred. The hygiene compliance indicator can further comprise an indicator, located on or in the wearable device, that is configured to alert a user that a hygiene-related timing condition has been met subsequent to the occurrence of the fluid interaction with the fluid sensor. The hygiene compliance indicator can further comprise a power source. The hygiene compliance indicator can further comprise a control circuit. The control circuit can be provided with logic and configured to: provide a minimum hygienic timing condition; provide a timing device; receive the sensor signal from the fluid sensor; use power from the power source to drive the control circuit; and provide information to the indicator that the minimum hygienic timing condition has been satisfied.

In some embodiments of a hygiene compliance indicator, the wearable device is configured to associate with the user's wrist; the wearable device may be a bracelet. In some embodiments, the wearable device is configured to associate with at least one of the user's fingers. In some embodiments, the fluid sensor comprises two non-continuous fluid-exposed conductors. In some embodiments, the indicator comprises a light source configured to emit light visible to the user; the light source may be a light emitting diode and/or may be housed within the wearable device. In some embodiments, the indicator comprises an audio source. In some embodiments, the power source is a battery; the power source may be located on or in the wearable device. In some embodiments, the minimum hygienic timing condition is at least approximately a twenty-second period of time. In some embodiments, the timing device is a timing circuit. In some embodiments, the control circuit is further configured to provide information to the indicator that a fluid interaction has occurred; the control circuit may be housed within the wearable device. In some embodiments, the wearable device comprises an outer housing portion made of a water-tight polymer. In some embodiments, at least a portion of the outer housing is light transmissive. In some embodiments, at least a portion of the transparent portion is in the form of a medically recognized symbol.

In some embodiments, there is provided a hygiene compliance indicator. The hygiene compliance indicator can comprise a wearable device configured for wearing on or near a user's hand such that exposure of the hand to fluid while the hand is being washed leads to direct exposure of the device to washing fluid. The hygiene compliance indicator can further comprise a fluid sensor located on or in the wearable device comprising one or more fluid-exposed wires that are sensitive to a physical trigger event, the trigger event comprising a physical interaction with a fluid, the fluid sensor further configured to provide a detection signal indicating that the physical trigger event has occurred, thereby transmitting information that such fluid interaction has occurred. The hygiene compliance indicator can further comprise an indicator, located on or in the wearable device, comprising a light source that is configured to alert a user that the fluid interaction has occurred and that a subsequent hygiene-related timing condition has been met. The hygiene compliance indicator can further comprise a battery power source. The hygiene compliance indicator can further comprise a control circuit. The control circuit can be provided with logic and configured to: provide a minimum hygienic timing condition corresponding to a twenty-second period of time; provide a timing circuit; receive the sensor signal from the fluid sensor; use power from the battery power source to drive the control circuit; provide information to the indicator that a fluid interaction has occurred; and provide information to the indicator that the minimum hygienic timing condition has been satisfied.

In some embodiments, there is provided a hospital-calibrated hygiene compliance indicator. The hospital-calibrated hygiene compliance indicator can comprise timing circuitry and a wrist-band configured to be worn by a user near a hand, the wrist-band formed from hypo-allergenic plastic material and configured to carry or enclose timing circuitry. The hospital-calibrated hygiene compliance indicator can further comprise a memory within or embodied by the timing circuitry, the memory configurable to provide a minimum hygienic timing condition that has been tailored to correspond to an appropriate length of time hand-washing must occur to comply with a minimum standard hygiene protocol. The hospital-calibrated hygiene compliance indicator can further comprise a washing sensor configured to activate the timing circuitry when the user begins washing her hands, such that the timing circuitry measures a length of time from when the user begins washing until the minimum hygienic timing condition has been met. The hospital-calibrated hygiene compliance indicator can further comprise a signal configured to alert the user when the minimum hygienic timing condition has been met and indicate that the user may end washing activities.

### BRIEF DESCRIPTION OF THE DRAWINGS

The foregoing and other features, aspects and advantages of the present invention are described in detail below with reference to the drawings of advantageous embodiments, which are intended to illustrate and not to limit the invention. The drawings comprise several figures in which:

FIG. 1 illustrates certain embodiments of a wearable fluid-sensitive hygiene compliance device;

FIG. 2 illustrates certain embodiments of a hygiene compliance system implemented in a hospital;

FIGS. 3A and 3B illustrate views of certain embodiments of a wearable fluid-sensitive hygiene compliance device;

FIG. 4 illustrates certain embodiments of a hygiene compliance system;

FIG. 5 illustrates a schematic illustration of an embodiment of a control circuit associated with a hygiene compliance device;

FIG. 6A illustrates a schematic pinout of a 741 operational amplifier;

FIG. 6B illustrates a schematic pinout of a 555 timer integrated circuit;

FIG. 6C is a graphical illustration of the time delay of a timer circuit;

FIG. 7 illustrates certain embodiments of a process for indicating hygiene compliance;

FIG. 8 illustrates certain embodiments of a process for practicing hygiene compliance;

FIG. 9 illustrates an embodiment of a wearable fluid-sensitive hygiene compliance device;

FIG. 10 illustrates an embodiment of a hygiene compliance device.

### DETAILED DESCRIPTION

Although certain preferred embodiments, examples and illustrations are discussed below, inventive subject matter extends beyond the specifically disclosed embodiments to other alternative embodiments and/or uses and to modifications and equivalents thereof. Thus, the scope of the claims that may arise herefrom is not limited by any of the particular embodiments described below. For example, in any method or process disclosed herein, the acts or operations of the method or process may be performed in any suitable sequence and are not necessarily limited to any particular disclosed sequence. Various operations may be described as multiple discrete operations in turn, in a manner that may be helpful in understanding certain embodiments; however, the order of description should not be construed to imply that these operations are order dependent. Additionally, the structures, systems, and/or devices described herein may be embodied as integrated components or as separate components. For purposes of comparing various embodiments, certain aspects and advantages of these embodiments are described. Not necessarily all such aspects or advantages are achieved by any particular embodiment. Thus, for example, various embodiments may be carried out in a manner that achieves or optimizes one advantage or group of advantages as taught herein without necessarily achieving other aspects or advantages as may also be taught or suggested herein.

Various embodiments generally relate to hygiene compliance devices. More specifically, embodiments of the inventions described herein relate to methods and systems for a wearable fluid-sensitive hygiene compliance device indicating to a user that a timing condition has been met.

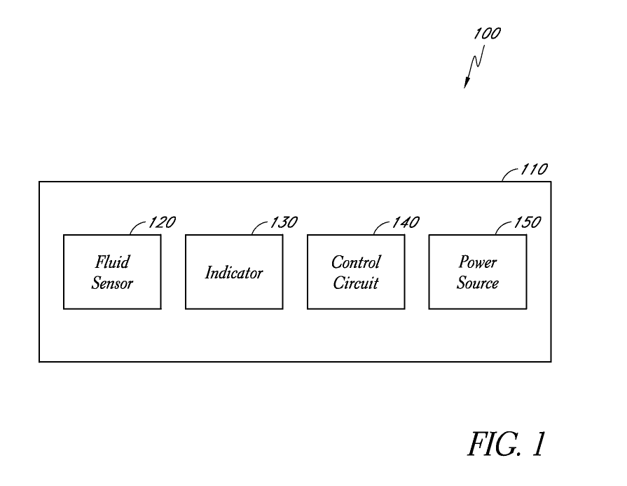

With reference to FIG. 1, there is shown a wearable fluid-sensitive hygiene compliance device 100, including a hand-associated structure 110, a fluid sensor 120, an indicator 130, a control circuit 140, and a power source 150. In this case, a hand-associated structure has been selected to illustrate the principles of the present invention; however, it will be understood that such principles may also apply to other types of wearable hygiene compliance devices, as well as to devices not necessarily limited to hygiene compliance.

The hand-associated structure 110 is configured to associate with the hand of a user such that when the user washes at least a portion of his or her hands in proximity to the hand-associated structure with washing fluid, the device is directly exposed to washing fluid. The term “hand-associated structure” is interpreted broadly to mean any structure wearable by a user on a portion of the user's body where such portion is close enough to at least one of the user's hands that some amount of washing fluid contacting such hand(s) during hand washing is likely to come in contact with the structure. The hand-associated structure can be a bracelet, associated with the user's wrist. Some amount of water flowing from a faucet or other water source that comes in contact with one or more of a user's hands during hand washing also comes in contact with the bracelet. The hand-associated structure may be configured to be size-adjustable, so as to be wearable on various body portions or body portions of various sizes. In some embodiments, the hand-associated structure is predominantly one color (e.g., white) before being contacted by a washing fluid, at which time the structure can be said to be “unactivated.”

The hand-associated structure 110 can comprise a water-proof outer housing, which houses one or more internal elements. For example, the outer housing may house the indicator 130, the control circuit 140, the power source 150, and at least some portion of the fluid sensor 120. In certain embodiments, the internal elements have a small enough footprint to fit within a bracelet.

With further reference to FIG. 1, the fluid sensor 120 can be located on or in the hand-associated structure 110. The fluid sensor 120 is configured to be sensitive to a physical interaction with a fluid and provide a detection signal indicating the occurrence of such fluid interaction. In some embodiments, the fluid sensor comprises water-sensitive contacts associated with a circuit. Such contacts can comprise portions of an open circuit that is “completed” electrically when a continuous fluid path exists between the two contacts. The contacts can thus play a role similar to that of electrodes or electrical leads, and the fluid can play the role of a conductive portion of a switch that is closes between the leads.

In some embodiments, the fluid sensor can comprise a water-reactive passive coating.

With further reference to FIG. 1, the indicator 130 can be located on or in the hand-associated structure 110. The indicator 130 is configured to alert the user that a hygiene-related timing condition has been met subsequent to the occurrence of a fluid interaction with the fluid sensor 120. The indicator can be configured to alert a user first that a fluid interaction with the fluid sensor has occurred, and second that a hygiene-related timing condition has been met. For example, the alert associated with the occurrence of a fluid interaction with the fluid sensor may comprise illuminating a light source visible to the user; the alert associated with the hygiene-related timing condition having been met may comprise terminating illumination of such light source. By illuminating a light source during the time between the occurrence of the fluid interaction and the satisfaction of the hygiene-related timing condition, the device may provide a constant reminder to the user to continuously engage in hand washing. The light may provide the advantage of helping the user remain focused on the task of hand washing for the relevant period of time.

In some embodiments, the indicator does not provide the first alert (i.e., that a fluid interaction with the fluid sensor has occurred), but still provides the second alert (i.e., that the hygiene-related timing condition has been met). This approach can be advantageous because it is less obtrusive and may be preferred by some users who wish to have only a bare reminder at the end of the relevant time period. In this case, the indicator or an associated circuit may have recorded a beginning time to allow the timed period to begin, even if the user is not alerted until the end of the timed period.

In some embodiments, the indicator is a light source (e.g., a low-power light source, such as a light emitting diode). In certain embodiments, the indicator comprises an audio signal, such as a speaker, or a vibration mechanism, or any other means of alerting a user. For example, the indicator can be a portion of the device that changes its shape or its color. Other physical, optical, aural, or tactile properties such as transparency, rigidity, roughness, etc. can also change to alert the user.

The hygiene compliance device of FIG. 1 can provide a number of advantages associated with the placement of the indicator 130 on or in the hand-associated structure 110. For example, when the indicator 130 is near the hand, it is in the line of sight of the user during hand washing. Therefore, the user can monitor the indicator 130 and monitor his or her hands simultaneously. The user may also be more likely to monitor the indicator 130 in the first place because he or she may already be looking in the direction of his or her hands during hand washing, and the indicator would therefore be in the user's line of sight.

The indicator 130, being located on or in the hand-associated structure, draws the attention of the user to the hand region. This may help the user avoid distractions during hand washing. The indicator 130 may, in fact, signify to the user the importance of hand washing generally, and therefore motivate him or her to take the task more seriously.

The proximity of the indicator to the user may allow for more subtle alerting means than would otherwise be practical. For example, with respect to embodiments comprising a light source indicator, the size and/or brightness of a light source necessary to draw the attention of a user is smaller/less when the light source is within arm's length than when it is farther away. Therefore, the light may be less distracting to others nearby. With respect to embodiments comprising audio source indicators, the volume of the indicator necessary to alert a user is likewise less when the indicator is within arm's length. The louder an alert is, the more likely it may be to cause an annoyance to others. Therefore, it is desirable to have an audio source indicator within arm's length, as opposed to more distant. Furthermore, with respect to hygiene compliance devices utilized by a clinician in a hospital, loud and/or bright indicators may alarm or agitate patients. Therefore, it may be desirable to place the indicator 130 on or in the hand-associated device 110 in order to alleviate patient agitation or alarm.

With respect to embodiments comprising a light source indicator, the indicator can be configured to be visible both to the user and to others who come within its visible range. Therefore, while minimally distracting to others nearby, the indicator may be visible by and/or acknowledged by an individual, such as a supervisor, performing a hygiene/sanitation audit.

With further reference to FIG. 1, the control circuit 140 can be located on or in the hand-associated structure 110. The control circuit 140 can be configured to provide a minimum hygienic timing condition and provide information to the indicator 130 that the minimum hygienic timing condition has been satisfied. The control circuit 140 is configured to receive a signal from the fluid sensor 120 indicating that a fluid interaction with the fluid sensor has occurred. Upon receipt of such signal, the control circuit 140 initiates a timing sequence, or otherwise employs means of measuring when a pre-determined amount of time has elapsed since the receipt of the signal indicating the occurrence of the fluid interaction. The pre-determined amount of time can correspond to a minimum hygienic timing condition; when the pre-determined amount of time elapses, the minimum hygienic timing condition is satisfied. When the minimum hygienic timing condition is satisfied, the control circuit 140 provides that information to the indicator 130, and the indicator alerts the user. The control circuit 140 may also, immediately upon occurrence of the fluid interaction, signal the indicator 130 to provide an indication to the user that the fluid interaction has occurred; the user is thereby informed that the hand washing time period has begun.

With further reference to FIG. 1, the power source 150 is located on or in the hand-associated structure. The power source 150 provides power to the control circuit 140. In some embodiments, the power source is a battery. There are a number of battery options that can provide desirable voltage and lifetime for the system, and are small enough to be embedded in the hand-associated structure itself. For example, 12, 9, or 5 volt batteries, or batteries of other voltages may be sufficient. In certain embodiments, a standard watch battery provides power to the circuit.

In certain embodiments, multiple uses of the wearable fluid-sensitive hygiene compliance device 100 are possible. In some such embodiments, after the device actively indicates to the user that the minimum hygienic timing condition has been satisfied following the occurrence of a fluid interaction it returns to a ready state and can respond to a subsequent fluid interaction in a similar manner. In certain embodiments, the control circuit 140 is capable of a certain number of cycles in a day (e.g., forty). Embodiments capable of multiple uses can provide the advantage of being more economical than single-use devices because such devices require less frequent replacement. In addition, the inconvenience associated with replacing a device after a single use may be alleviated with devices capable of multiple uses.

In certain embodiments, the outer housing comprises material capable of disinfection/sanitization, thus facilitating multiple sanitary uses of the device. In some embodiments, the housing comprises silicon rubber. Sanitization and hygiene compliance are particularly desirable in a hospital environment, where contact with sick and/or sensitive patients is common. Devices capable of disinfection/sanitization may be desirable in other environments as well (e.g., food kitchens, day care centers, restaurants, elder-care centers, or any environment dealing with health or food or person-to-person contact, whether direct or indirect).

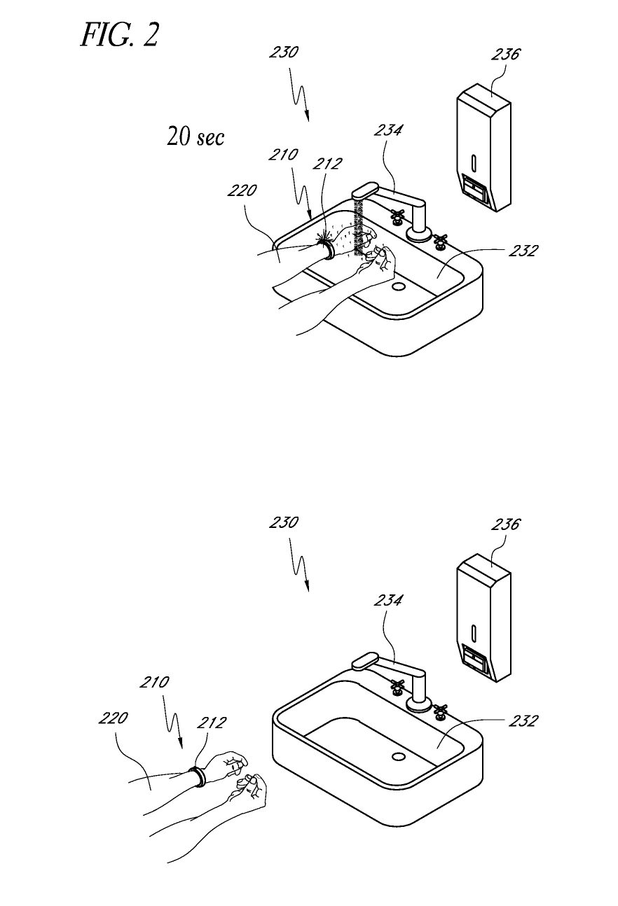

FIG. 2 illustrates an example of a hygiene compliance system 200 that can be implemented in a hospital, for example. A hospital may be an appropriate setting for implementation of a hygiene compliance system because germ transmission can be a particular concern in hospitals. The system 200 comprises a wearable fluid-sensitive hygiene compliance device 210 coupled to an upper appendage of a clinician 220, such as a nurse or doctor. The system is configured such that when the clinician 220 washes his or her hands at a washing station 230, water from the water station comes in contact with the wearable fluid-sensitive hygiene compliance device 210. The washing station can comprise a sink 232, a water faucet 234, and a soap dispenser 236. An indicator 212 located on or in the device 210 actively indicates to the user that a minimum hygienic timing condition has been met, and therefore the clinician 220 is in compliance with relevant hygiene requirements. In some embodiments, the indicator 212 may provide the advantage of providing a visual confirmation to the user, as well as to other interested parties within the device's visual range, that the user has adequately washed his or her hands with respect to relevant hygiene standards; the user may display the device to a supervisor in order to demonstrate compliance. The hygiene compliance system therefore may allow the user to have confidence that he or she is in compliance with hygiene requirements as he or she works. In certain embodiments, the indicator 212 indicates compliance to the user by turning off an illuminated light source. In some embodiments, the indicator 212 is configured to indicate compliance, or completion, twenty seconds after initiation of hand washing. In certain embodiments, after contact with washing fluid, the device alerts a user that a minimum hygienic timing condition has been met after a predetermined period of time, but cannot be reset during that period.

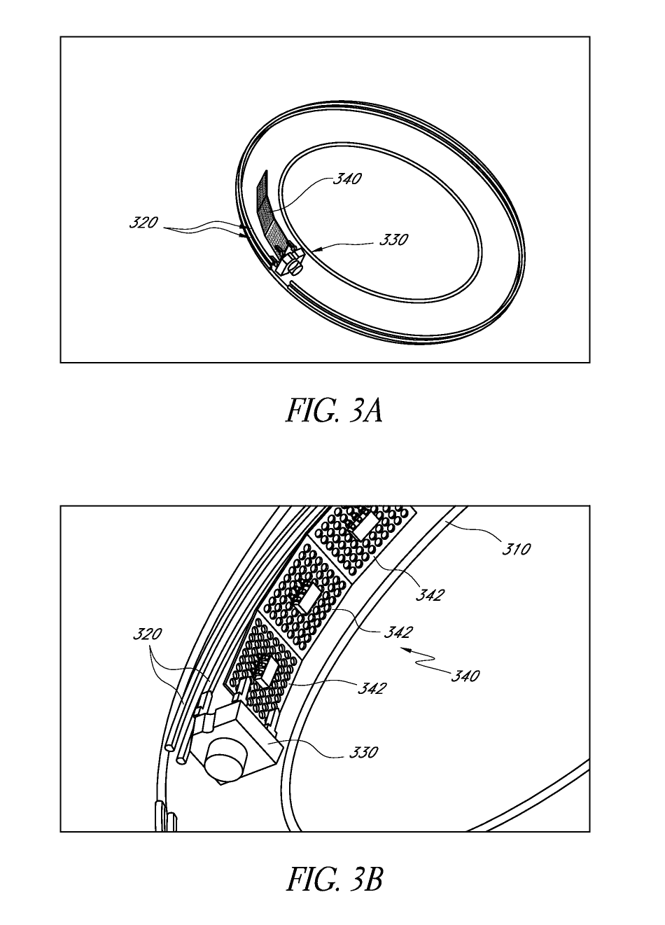

FIGS. 3A and 3B are views of an embodiment of a wearable fluid-sensitive hygiene compliance device. The device 300 of FIGS. 3A and 3B comprises an outer housing 310, which houses a number of device elements. In some embodiments, the elements housed within the outer housing 310 are embedded in silicon potting adhesive. In the present embodiment, the outer housing comprises a water-tight transparent polymer. In certain embodiments, the outer housing comprises opaque material, or materials allowing for varying degrees of light transmission. In certain embodiments, the outer housing includes material capable of disinfection (e.g., silicon rubber), thus facilitating multiple sanitary uses of the device. In certain embodiments, the outer housing comprises a material having elasticity or resiliency. This can facilitate wearing the material on a wrist and slipping it past a wider body portion such as a hand, for example. In certain embodiments, the outer housing can comprise a material suitable for contact with human skin. For example, the material can be selected or configured to avoid skin irritation and/or allergic reactions.

With further reference to FIGS. 3A and 3B, the device 300 can include a fluid sensor comprising two generally parallel wires 320. In the illustrated embodiment, the wires 320 run along the circumference of the device and do not come into electrical contact with each other. The wires 320 are positioned such that fluid contact with the portion of the outer housing 310 on which the wires sit establishes electrical conductivity between the wires. In some embodiments, the wires are positioned approximately 1 mm apart. The wires 320 are connected to one or more elements housed within the outer housing 310.

The wearable fluid-sensitive hygiene compliance device of FIGS. 3A and 3B further comprises a light source 330, which operates as a hygiene compliance indicator. In some embodiments, the light source indicator 330 is a light emitting diode. A light emitting diode may be controlled by measured conductivity through a detection area. In certain embodiments, the hygiene compliance indicator comprises an audio source, such as a speaker.

With further reference to FIGS. 3A and 3B, the wearable fluid-sensitive hygiene compliance device 300 comprises a control circuit 340. The control circuit 340 can comprise multiple electrically connected circuit boards 342. The use of multiple circuit boards may allow the circuitry to conform to the curvature of the wearable fluid-sensitive hygiene compliance device 300. In certain embodiments, the control circuit comprises a single circuit board. In certain embodiments, circuit elements are mounted on flexible circuitry. The control circuit is connected to the fluid sensor 320. The control circuit 340 may be configured to send a signal to activate the light source 330 for a period of time upon receiving a signal from the fluid sensor 320.

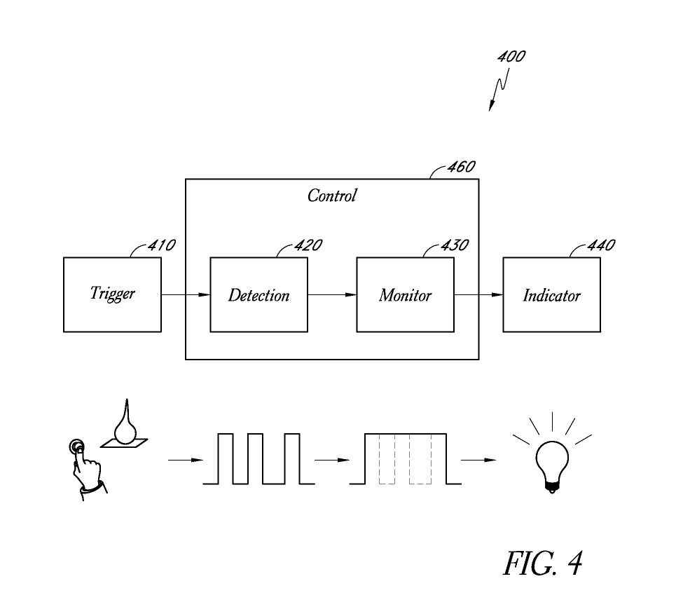

FIG. 4 illustrates an embodiment of a hygiene compliance system 400. In the depicted embodiment, the hygiene compliance system includes a trigger module 410, a detection module 420, a monitor module 430, and an indicator module 440. The detection module 420 and the monitor module 430 collectively represent the control module 460.

The trigger module 410, upon occurrence of a triggering event, such as the occurrence of a fluid interaction with a fluid sensor, provides a trigger signal to the detection module 420. In certain embodiments, the triggering event is the pressing of a button, flipping of a switch, detection of a magnetic or radio sensor, or any other feasible event. In especially advantageous embodiments, the triggering event is most likely to happen when hygienic compliance is beginning or occurring, and much less likely to happen under other common circumstances encountered by the user of the device. For example, the triggering event can be when the device encounters a particular kind of soap; when it encounters water of a certain temperature; or when the body portion(s) to be cleaned (e.g., the hands) are subjected to ultraviolet light or some other substance or event that leads to an increase in sanitation. Embodiments described herein refer to fluid detection as a triggering event because fluids are often used to achieve more hygienic conditions.

Upon receipt of the trigger signal from the trigger module, the detection module 420 provides a detection signal to the monitor module that can resemble a step function, as illustrated; the detection signal has a first value 422 upon receipt of a trigger signal, and a second distinct value 424 when no trigger signal has been presently received. In certain embodiments, detection operations are performed by an operational amplifier.

Upon receipt of the detection signal, the monitor module 430 provides a monitor signal to the indicator module 440 that can resemble a step function. In the steady state, in the absence of a detection signal having the first value 422, the monitor signal has a value 434 that is less than a threshold necessary to drive the indicating means of the indicator module 440. Upon receipt of a detection signal having the first value while in the steady state, and thereafter for a predetermined period of time, the monitor signal has a value 432 which is greater than a threshold necessary to drive the indicating means of the indicator module 440. After the predetermined period of time, the monitor signal returns to the below threshold value.

The predetermined period of time can advantageously correspond to a minimum hygienic timing condition. The minimum hygienic timing condition can be established empirically and the predetermined period of time can be built in to the system by the configuration and choice of circuitry and subcomponents thereof. In some embodiments, the predetermined period of time can be adjustable by the user or by a configuring entity. For example, the protocol of one health care provider and/or insurer and/or government entity (e.g., the center for disease control) may call for a shorter minimum time period for hand washing (e.g., 20 seconds) and the protocol of another such entity may call for a longer minimum time period (e.g., 30 seconds). Moreover, health care professions involved in some high risk activities or stationed in particularly sensitive portions of a hospital (e.g., the newborn intensive care unit or the operating room) may have more stringent washing requirements than would otherwise be prudent to enforce. The Centers for Disease Control and Prevention (CDC) recommend washing hands for at least 15-20 seconds to prevent the spread of infection and illness.

If the monitor module receives a detection signal having the first value within the predetermined period of time after receipt of a prior detection signal having the first value, the monitor signal in insensitive to such detection signal. In certain embodiments, the monitor signal has a value greater than the threshold 432 only when the detection signal has the first value 422, i.e., the monitor signal does not continue to have a non-zero value for a period of time after receipt of a detection signal having the first value 422.

The indicator module 440 receives a monitor signal from the monitor module 430. Upon receipt of a monitor signal having an above-threshold value 432, the indicator module alerts a user by some indicating means. In some embodiments, the indicator module alerts a user by illuminating a light source, such as, for example, a light emitting diode light source. In some embodiments, the indicator module alerts a user by implementing an audio source or a tactile response that can be felt by the user.

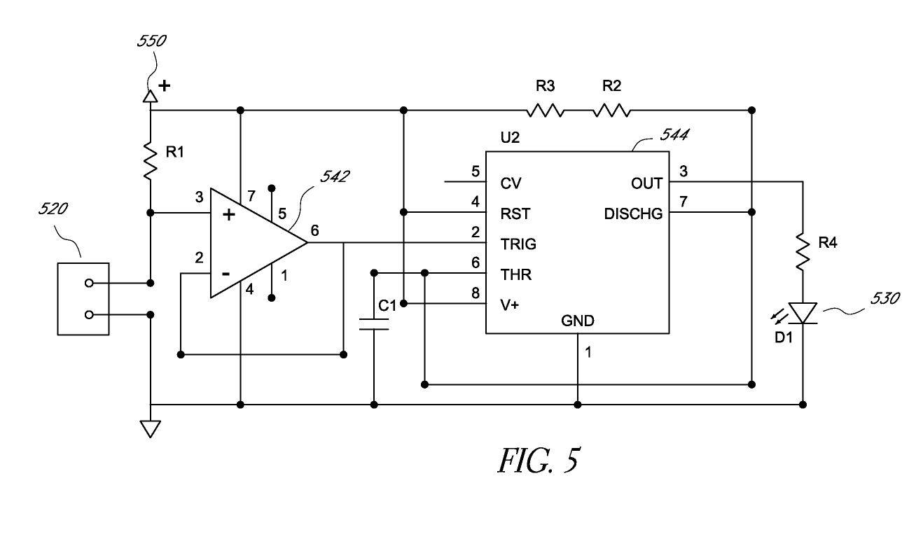

FIG. 5 is a schematic illustration of an embodiment of the control circuit 140 described above. The control circuit 500 comprises an operational amplifier (“op-amp”) 542, a timing circuit 544, as well as a number of other circuit elements. Components numbered R1-R4 represent resistors. The component numbered C1 represents a capacitor.

With further reference to FIG. 5, element 550 represents the power source that drives the control circuit 500. In some embodiments, the power source 550 is a battery. Element 520 represents a trigger mechanism, such as the fluid sensor 120, or other trigger means, such as a switch. In some embodiments, the trigger mechanism 520 comprises two wires that are configured in such a way as to make it possible for small amounts of water to bridge the gap between them, creating an electrical connection which shorts the control circuit at 520. The two circuit branches leading into the trigger mechanism 520 are an open circuit in the absence of a trigger signal received by the trigger mechanism. When the trigger mechanism 520 is an open circuit, that is, there is no conduction between the two branches, the voltage provided to the op-amp is the voltage of the power source 550. When the trigger mechanism 520 is a closed circuit, that is, there is conduction between the two branches, the voltage provided to the op-amp is approximately zero, as the voltage from the power source 550 is dropped to ground and dissipated over the resistor R1. Therefore, R1 governs the current driven when trigger module 520 is short-circuited. In some embodiments, R1 has a value of 100 kilohms. However, as is the case with respect to all of the various circuit elements depicted in FIG. 5, the circuit may function satisfactorily with different values of R1 than is specifically depicted herein.

In some embodiments, the timing circuit 504 is configured to provide a stable output over a period of time, depending on the occurrence of a trigger event. In certain embodiments, intermittent high voltages generated by the op-amp 502 can be used to trigger a stable output pulse that can be used to illuminate a light emitting diode D1. In certain embodiments, the timing circuit 504 is configured such that a stable output may be triggered, but not re-triggered until after a period of time.

The light emitting diode (LED) D1 is driven by the output of the timing circuit 504. The resistor R4 protects D1 when the supply voltages are too high. In some embodiments, R4 has a value of 1 kilohm. In some embodiments, the LED D1 is substituted with another indicating means. For example, the indicating means may comprise a non-LED light source, a vibrating mechanism, an audio source, or other indicating means.

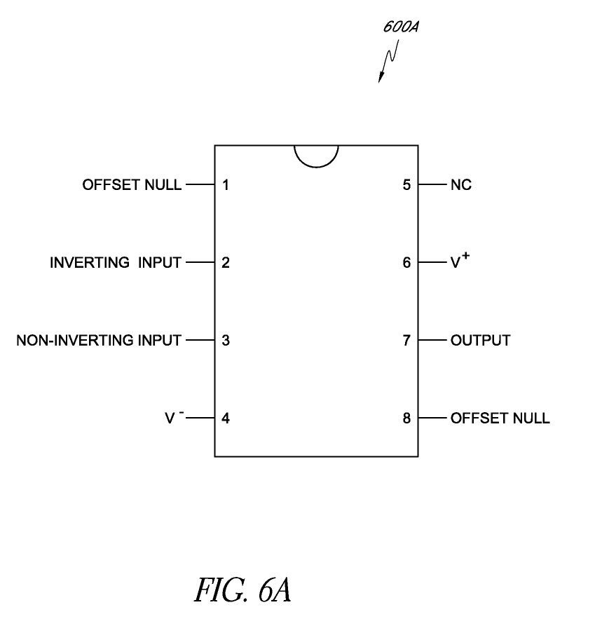

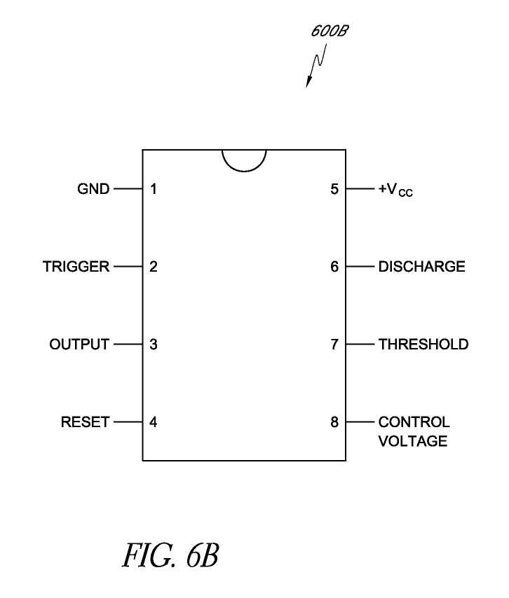

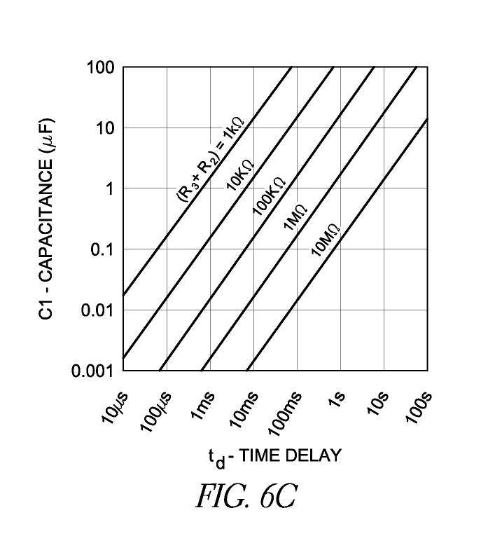

FIGS. 6A and 6B illustrate schematic pin-outs of a 741 op-amp 600A and a 555 timer integrated circuit 600B, both of which are examples of circuit elements that may be utilized as components of the control circuit 500, discussed above with reference to FIG. 5. The particular advantages of the 741 op-amp and the 555 timer integrated circuit will be understood by one having ordinary skill in the art. The meanings of the individual pin labels of the depicted pin-outs 600A and 600B will likewise be understood by one having ordinary skill in the art. The numbers associated with the individual pins (1 through 8 in both pinouts) correspond do the numbered pin designations of the respective elements in the circuit diagram of FIG. 5.

The 555 timer integrated circuit output can give time delay periods of milliseconds to hours, controlled by the values of R3, R2 and C1, shown in circuit diagram of FIG. 5. Therefore, a hygiene compliance device comprising a 555 timer integrated circuit may be programmed to indicate compliance to a user after a number of different periods of time, controlled by the values of R3, R2 and C1. This allows for some flexibility in the amount of time required for compliance, and therefore the device may satisfy varying hygiene standards. The resultant time delay of the timing circuit 600B with regard to various selections of values of R3, R2 and C1 are graphically illustrated in FIG. 6C. In some embodiment, R3 and R2 each have values of 1 mega ohm, and C1 has a value of 4.7 microfarads. In some embodiments of the control circuit 500 of FIG. 5, R1 and R1 are substituted with a single resistor, or with multiple resistors configured in series.

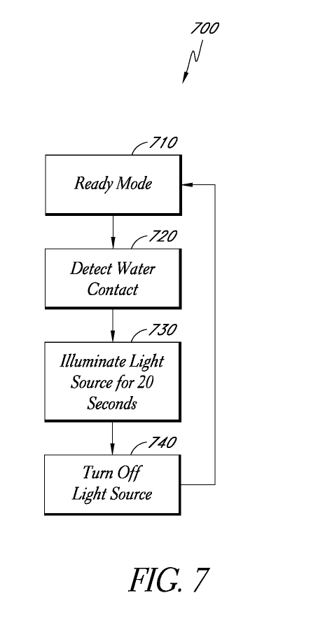

FIG. 7 illustrates an embodiment of a process 700 for indicating hygiene compliance. The process 700 is described with reference to the fluid-sensitive hygiene compliance device 100 described above. However, the process 700 can be implemented by any of the other systems described herein. The process 700 can indicate hygiene compliance based on a human subject's hand washing duration.

At block 710 of the process 700, a fluid-sensitive hygiene compliance device is initially in a ready mode. The device will remain in ready mode until physical contact by the device with water is detected at block 720. In some embodiments, block 720 is substituted with a block associated with another trigger event, such as the pressing of a button, or the detection of a magnetic or radio signal.

Following the detection of water contact with the device 720, a light source located on or in the device is illuminated for a period of time associated with a minimum hygienic timing condition. This step is accomplished at block 730. In the present embodiment, the relevant period of time is twenty seconds. The twenty-second time period corresponds to recommended hand washing standards. However, the period of time for which the light source is illuminated may vary and may be any desirable hygiene-related period of time. After the relevant period of time has elapsed, the light source is turned off at block 740, after which the device returns to ready mode 710.

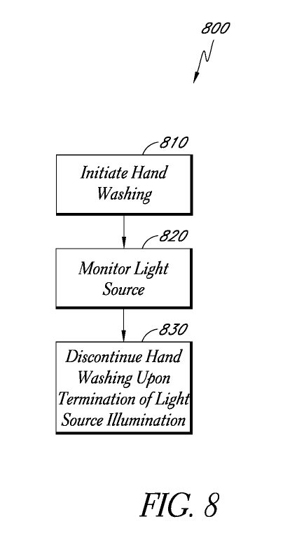

FIG. 8 illustrates an embodiment of a process 800 for practicing hygiene compliance. The process 800 is described with reference to the fluid-sensitive hygiene compliance device 100 described above. However, the process 800 can be implemented by any of the other systems described herein. The process 800 relates to a human subject's hygiene compliance practice based on hand washing duration.

At block 810 of the process 800, a human subject, or device user, initiates hand washing. In some embodiments, the subject initiates hand washing using washing fluid, such that at least some amount of washing fluid comes in contact with a fluid-sensitive hygiene compliance device worn by the subject. In some embodiments, the subject initiates hand washing by dispensing a washing agent from a dispenser.

Following initiation of hand washing 810, the subject monitors a light source 820, while continuously engaging in hand washing. In an embodiment, the light source is illuminated throughout the step represented by block 820. In an embodiment, the block 820 is substituted with a block associated with monitoring another indicator, such as listening for an audible indication, feeling for a physical vibration, or the like. At block 830, the subject acknowledges a compliance signal from the light source, or other indicator, by discontinuing hand washing, at which point the subject has satisfactorily complied with hygiene requirements.

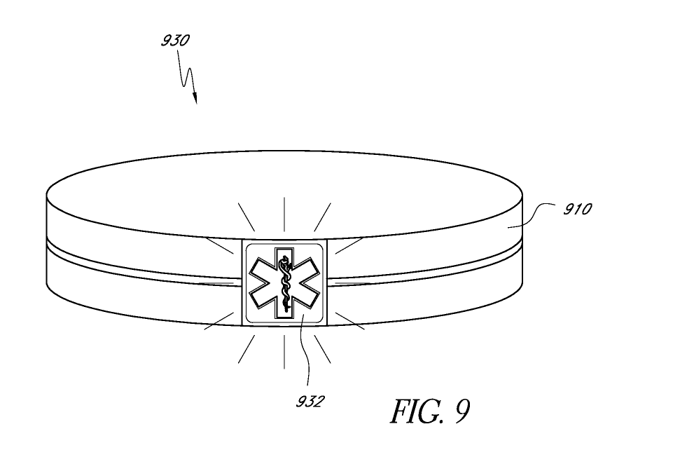

FIG. 9 illustrates an embodiment of a wearable fluid-sensitive hygiene compliance device. The device comprises an outer housing 910 and a light source indicator 930. The light source is housed within a portion of the outer housing 910 of the device. At least a portion of the outer housing, specifically, a portion of the outer housing adjacent to the light source, comprises light transmissive material 932, such that light from the light source is visible outside of the outer housing 910 through the light transmissive material. In the present embodiment, the light transmissive material 932 is configured such that light visible outside of the outer housing displays a medically recognizable symbol. The medically recognizable symbol may add to the aesthetic appeal of the device. The symbol may also add to the acceptability of the device by indicating to users and patients that the device is hospital-sanctioned.

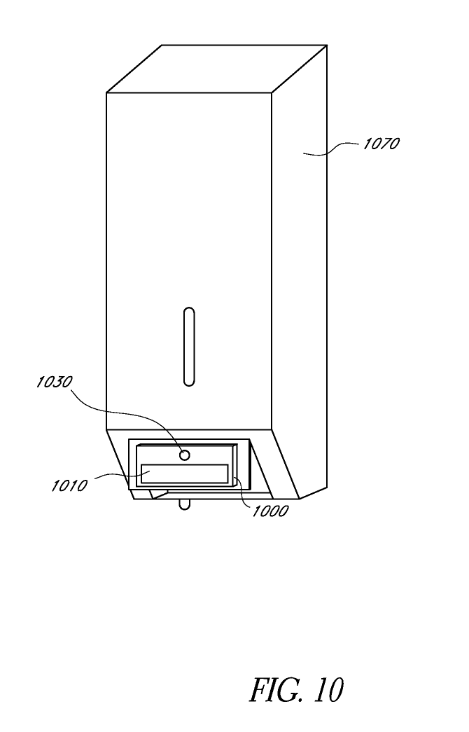

FIG. 10 illustrates an embodiment of a hygiene compliance device 1000. The hygiene compliance device 1000 comprises a button 1010 that is configured to be pressed by a user. In some embodiments, the button is substituted with another detection means, such as a magnetic or radio signal detection means. The button 1010, or other detection means, is configured to provide a trigger signal to a control circuit (not shown) when triggered. The control circuit is housed within the device 1000. The control circuit comprises a timing circuit that illuminates a light 1030 for a predetermined period of time upon receipt of a trigger signal.

The hygiene compliance device 1000 can be configured to be capable of attachment to a soap dispenser 1070, such that the means required to dispense soap from the soap dispenser automatically triggers the detection means 1010. A hygiene compliance device can be configured to retro-fit an existing soap dispenser, for example. In such a configuration, the device can begin a countdown or timer when soap is dispensed and alert a user when a certain time has passed (signaling the appropriate time for rinsing off the soap, for example, or signaling that the user has complied with a protocol). Some embodiments can include an external sensor on a soap dispenser; some embodiments can include an internal sensor couched within or integrated into a component of a soap dispenser. The sensor can be a pressure-activated switch that begins a counter, ultimately illuminating a light after a certain time has passed. In some embodiments a hygiene compliance device—such as those described herein—can be calibrated for use in a hospital, but it can also be calibrated for use in other settings where hygiene is advantageous, such as restaurants, schools, food packaging plants, correctional facilities, etc.

The control circuit is configured to drive a light source 1030, or other indicator. In certain embodiments, the indicator is an audio source configured to provide an audible signal to a user. The control circuit is configured such that at a predetermined period of time after the button 1010 is pressed, the indicator 1030 indicates to a user that a minimum hygiene condition has been satisfied.

Reference throughout this specification to “certain embodiments,” “some embodiments,” or “an embodiment” means that a particular feature, structure or characteristic described in connection with the embodiment may be included, but not all these references refer to the same embodiment and may refer to one or more of the same or different embodiments. Furthermore, the particular features, structures or characteristics can be combined in any suitable manner, as would be apparent to one of ordinary skill in the art from this disclosure, in one or more embodiments.

As used in this application, the terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Similarly, it should be appreciated that in the above description of embodiments, various features are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that any claim require more features than are expressly recited in that claim. Rather, inventive aspects lie in a combination of fewer than all features of any single foregoing disclosed embodiment.

Methods and processes described herein may be embodied in, and partially or fully automated via, software code modules executed by one or more general and/or special purpose computers. The words “circuitry” and “module” can refer to logic embodied in hardware and/or firmware, or to a collection of software instructions, possibly having entry and exit points, written in a programming language, such as, for example, C or C++. A software module may be compiled and linked into an executable program, installed in a dynamically linked library, or may be written in an interpreted programming language such as, for example, BASIC, Perl, or Python. It will be appreciated that software modules may be callable from other modules or from themselves, and/or may be invoked in response to detected events or interrupts. Software instructions may be embedded in firmware, such as an erasable programmable read-only memory (EPROM). It will be further appreciated that hardware modules may be comprised of connected logic units, such as gates and flip-flops, and/or may be comprised of programmable units, such as programmable gate arrays, application specific integrated circuits, and/or processors. The modules described herein are preferably implemented as software modules, but may be represented in hardware and/or firmware. Moreover, although in some embodiments a module may be separately compiled, in other embodiments a module may represent a subset of instructions of a separately compiled program, and may not have an interface available to other logical program units.

In certain embodiments, code modules may be implemented and/or stored in any type of computer-readable medium or other computer storage device. In some systems, data (and/or metadata) input to the system, data generated by the system, and/or data used by the system can be stored in any type of computer data repository, such as a relational database and/or flat file system. Any of the systems, methods, and processes described herein may include an interface configured to permit interaction with patients, health care practitioners, administrators, other systems, components, programs, and so forth.

Although described in the illustrative context of certain preferred embodiments and examples, it will be understood by those skilled in the art that the disclosure extends beyond the specifically described embodiments to other alternative embodiments and/or uses and obvious modifications and equivalents. Thus, it is intended that the scope of the claims which follow should not be limited by the particular embodiments described above.

What is claimed is:

1. A hygiene compliance indicator comprising:
A wearable device configured for wearing on or near a user's hand such that exposure of the hand to fluid while the hand is being washed leads to direct exposure of the device to washing fluid;
a fluid sensor located on or in the wearable device and having at least one fluid-exposed portion that is sensitive to a physical trigger event, the trigger event comprising a physical interaction with a fluid, the fluid sensor further configured to provide a detection signal indicating that the physical trigger event has occurred, thereby transmitting information that such fluid interaction has occurred;
an indicator, located on or in the wearable device, that is configured to alert a user that a hygiene-related timing condition has been met subsequent to the occurrence of the fluid interaction with the fluid sensor;
a power source; and
a control circuit provided with logic and configured to:
provide a minimum hygienic timing condition;
provide a timing device;
receive the sensor signal from the fluid sensor;
use power from the power source to drive the control circuit; and
provide information to the indicator that the minimum hygienic timing condition has been satisfied.

2. The hygiene compliance indicator of claim 1, wherein the wearable device is configured to associate with the user's wrist.

3. The hygiene compliance indicator of claim 1, wherein the wearable device is configured to associate with at least one of the user's fingers.

4. The hygiene compliance indicator of claim 2, wherein the wearable device is a bracelet.

5. The hygiene compliance indicator of claim 1, wherein the fluid sensor comprises two non-continuous fluid-exposed conductors.

6. The hygiene compliance indicator of claim 1, wherein the indicator comprises a light source configured to emit light visible to the user.

7. The hygiene compliance indicator of claim 6, wherein the light source is a light emitting diode.

8. The hygiene compliance indicator of claim 6, wherein the light source is housed within the wearable device.

9. The hygiene compliance indicator of claim 1, wherein the indicator comprises an audio source.

10. The hygiene compliance indicator of claim 1, wherein the power source is a battery.

11. The hygiene compliance indicator of claim 1, wherein the minimum hygienic timing condition is at least approximately a twenty-second period of time.

12. The hygiene compliance indicator of claim 1, wherein the timing device is a timing circuit.

13. The hygiene compliance indicator of claim 1, wherein the control circuit is further configured to provide information to the indicator that a fluid interaction has occurred.

14. The hygiene compliance indicator of claim 1, wherein the power source is located on or in the wearable device.

15. The hygiene compliance indicator of claim 1, wherein the control circuit is housed within the wearable device.

16. The hygiene compliance indicator of claim 1, wherein the wearable device comprises an outer housing portion made of a water-tight polymer.

17. The hygiene compliance indicator of claim 16, wherein at least a portion of the outer housing is light transmissive.

18. The hygiene compliance indicator of claim 17, wherein at least a portion of the transparent portion is in the form of a medically recognized symbol.

19. A hygiene compliance indicator comprising:
A wearable device configured for wearing on or near a user's hand such that exposure of the hand to fluid while the hand is being washed leads to direct exposure of the device to washing fluid;
a fluid sensor located on or in the wearable device comprising one or more fluid-exposed wires that are sensitive to a physical trigger event, the trigger event comprising a physical interaction with a fluid, the fluid sensor further configured to provide a detection signal indicating that the physical trigger event has occurred, thereby transmitting information that such fluid interaction has occurred;
an indicator, located on or in the wearable device, comprising a light source that is configured to alert a user that the fluid interaction has occurred and that a subsequent hygiene-related timing condition has been met;
a battery power source; and
a control circuit provided with logic and configured to:
provide a minimum hygienic timing condition corresponding to a twenty-second period of time;
provide a timing circuit;
receive the sensor signal from the fluid sensor;
use power from the battery power source to drive the control circuit;
provide information to the indicator that a fluid interaction has occurred; and
provide information to the indicator that the minimum hygienic timing condition has been satisfied.

20. A hygiene compliance indicator comprising:
timing circuitry;
a wrist-band configured to be worn by a user near a hand, the wrist-band formed from hypo-allergenic plastic material and configured to carry or enclose the timing circuitry;
a memory within or embodied by the timing circuitry, the memory configurable to provide a minimum hygienic timing condition that has been tailored to correspond to an appropriate length of time hand-washing must occur to comply with a minimum standard hygiene protocol;
a washing sensor configured to activate the timing circuitry when the user begins washing her hands, such that the timing circuitry measures a length of time from when the user begins washing until the minimum hygienic timing condition has been met;
a signal configured to alert the user when the minimum hygienic timing condition has been met and indicate that the user may end washing activities.
